(19) United States
(12) Patent Application Publication
(10) Pub. No.: US 2025/0154729 A1
(43) Pub. Date: May 15, 2025

(54) Method of forming products from fibrous material and forming device

(71) Applicant: Kiefel GmbH, Freilassing (DE)

(72) Inventors: Peter Knoll, Ainring (DE); Benno Berger, Freilassing (DE)

(21) Appl. No.: 18/933,331

(22) Filed: Oct. 31, 2024

(30) Foreign Application Priority Data
Nov. 9, 2023 (DE) 10 2023 131 021.6

(51) Int. Cl. D21J 1/04; D21J 1/16

(52) U.S. Cl. CPC D21J 1/04; D21J 1/16

(57) ABSTRACT

A method for forming products from fibrous material and a forming device for forming products from a fibrous material are described, where a multi-stage pressing of preforms made of fibrous material is carried out in order to improve the properties of products manufactured therefrom and to have a significant influence on the production time.

### PRIORITY CLAIM

The present application claims priority under 35 U.S.C. § 119 to German Patent Application No. DE 10 2023 131 021.6, filed Nov. 9, 2023, the disclosure of which is incorporated by reference herein in its entirety.

### TECHNICAL FIELD

A method for forming products from fibrous material and a forming device for forming products from a fibrous material are described.

Fiber-containing materials are increasingly used, for example, to produce packaging for food (e.g., trays, capsules, boxes, etc.) and consumer goods (e.g., electronic devices, etc.) as well as beverage containers. The fibrous materials usually have natural fibers, which are obtained, for example, from renewable raw materials or waste paper. The natural fibers are mixed in a so-called pulp with water and optionally further additives, such as starch. Additives can also have an effect on color, barrier properties and mechanical properties. This pulp can have a proportion of natural fibers of, for example, 0.2 to 10% by weight. The proportion of natural fibers varies depending on the method used for the production of packaging etc. and the product properties of the product to be produced. In addition, fibrous materials are increasingly being used that can be processed in a dry state. These include, for example, airlaid and fluff pulp, crepe, paper, cardboard, etc.

### BACKGROUND

The production of fiber-containing products from a pulp generally takes place in a plurality of work steps. For this purpose, a fiber processing device has a plurality of stations or forming stations. In a forming station, for example, fibers can be suctioned in a cavity of a suction tool, thus forming a preform. For this purpose, the pulp is provided in a pulp supply, and the suction tool is at least partially immersed in the pulp with at least one suction cavity whose geometry essentially corresponds to the product to be manufactured. During the immersion, suction takes place via openings in the suction cavity, which are connected to a corresponding suction device, where fibers from the pulp accumulate on the surface of the suction cavity. The suctioned fibers or a preform can subsequently be brought into a pre-pressing tool via the suction tool, and the preform is pre-pressed. For this purpose, for example, it is possible to use elastic form bodies that are inflated in order to press and, in the process, exert pressure on the preforms. During this pre-pressing process, the fibers in the preform are compressed and the water content of the preform is reduced. Alternatively, preforms can be provided by means of scooping, where a scoop tool is immersed in the pulp and during startup fibers are deposited on formed parts of the scoop tool.

After this, preforms are pressed in a hot pressing device to form finished formed parts. In this process, preforms are inserted into a hot press tool that has, for example, a lower tool half and an upper tool half which are heated. In the hot press tool, the preforms are pressed in a cavity under heat input, with residual moisture being removed by the pressure and heat so that the moisture content of the preforms is reduced from about 60% by weight before hot pressing to, for example, 1-10% by weight after hot pressing. The steam produced during hot pressing is suctioned off during the hot pressing via openings in the cavities and channels in the hot press tool.

A production method and a fiber processing device are known, for example, from DE 10 2019 127 562 A1.

During hot pressing, it is crucial to sufficiently heat the preforms that have a relatively high water content, and to press them long enough in order to achieve the desired residual moisture in the finished product/item and to press the fibers so that a finished product with the desired geometries can be produced. The geometry or shape of the manufactured products is subject to restrictions because a relatively large deformation of a wet preform cannot be carried out without damage. This results in a long cycle time that has a detrimental effect on the entire manufacturing process and manufacturing costs.

Furthermore, it is not yet possible to sustainably influence the shape and formation of products made from a fibrous material during the hot pressing process. Deformations such as embossing, etc. cannot be achieved at all or only with great effort because the fibrous material shrinks when the water contained therein evaporates. Prior art forming tools for producing complex geometries usually have movable form surfaces. Such tools are expensive to purchase and fault-prone. Moreover, additional control for the moving form surfaces is required that increases the effort for such a tool.

In addition, it has been shown that previous attempts to achieve barrier properties in products made of a fibrous material are either very complex and costly, not recyclable or not sufficiently impermeable.

### SUMMARY

### Object

The object is therefore to present a solution for the production of products made from fibrous material, where products with complex geometries can be manufactured, and the disadvantages of the prior art are eliminated. In addition, a solution should be provided in which moving form surfaces for a tool are not required. Another object is to achieve improved barrier properties in products made from a fibrous material.

### Solution

The aforementioned object is achieved by a method for the forming of products made from a fibrous material that has at least the following steps:
providing a preform made of a fibrous material, where the preform has a moisture content of not more than 75% by weight,
first pressing of the preform with simultaneous heat input in a first pressing device, and
at least a second pressing of the preform previously pre-pressed in the first pressing device with simultaneous heat input in a second pressing device,
   where
the temperature introduced during the first pressing in the first pressing device and the temperature introduced during the at least one second pressing in the second pressing device are different.

By two-stage pressing, the pressing time per pressing device can be kept relatively short so that the production time is kept low or reduced even for complex geometries and for products or preforms with a high water content and large wall thicknesses (>1 mm). The pressing that would otherwise occur in a pressing device at high temperatures, as in the prior art, can take a very long time depending on the complexity, geometry and moisture of preforms so that upstream and downstream processing steps must be paused. The solution presented here contrastingly enables adaptation to, for example, the shortest processing time at another station (e.g., suction station, pre-press station, etc.).

Furthermore, in one of the pressing devices, additional deformation can be achieved in addition to drying (“hot pressing”). To make this possible, for example, the temperature in the first pressing device can be higher or lower than in the at least one second pressing device. The temperature differences also enable controllable water discharge so that damage to preforms is avoided if, for example, drying occurs first, and the maximum heating power is therefore not applied. It has also been shown that a better bond between the fibers is achieved by the temperature difference, whereas double pressing at basically the same temperature does not achieve the desired bond between the fibers and can even have a negative effect on the bond.

In addition, the pressing force in the first pressing device can be higher, lower or substantially the same as in at least one second pressing device. Finally, the duration of the pressing and also the duration of the heat exposure via the first pressing device and at least one second pressing device can differ between the at least two pressing devices.

In addition to reducing the cycle time during hot pressing, this allows a shaping of the preforms to be achieved and their barrier properties to also be improved. After an initial pressing, a preform can, for example, be sufficiently stable so that no additional shrinkage occurs during embossing in which, for example, wall or floor sections partially achieve a reduced wall thickness. For this purpose, for example, the pressing devices can have cavities with adapted form surfaces and geometries that differ from one another in the first and at least one second pressing device in order to take account of shrinkage or deformation, for example. By an at least two-stage pressing, the surface characteristics on the inside and/or outside of preforms or products can be significantly influenced. This includes embossing, for example to introduce patterns or structures in a surface, as well as thermal and pressure-specific effects that can be different in the at least two pressing steps (first pressing, second pressing). By a thermal and pressure-specific effect, the surfaces in particular can be more strongly compacted so that a barrier against liquids, gases and odors as well as pollutants can be achieved solely by the fibrous material without any additional additives. In other embodiments, by definable temperature ranges and different pressures, an activation or strong binding of additives can be achieved that are added to the fibrous material in order to achieve a barrier effect. In this case, the advantage of the two-stage method can be used, for example, that in a first step, the water content of a preform is significantly reduced so that this preform can be pressed in the at least one second pressing device in a second pressing with higher forces and temperatures in order to “close” a corresponding surface. The small remaining water content can be removed from the preform via the opposite surface. Since the moisture content has already been significantly reduced, damage etc. to the preform or product is excluded.

The first pressing and the at least one second pressing are part of a hot pressing process that, compared to known methods, is divided into at least two hot pressing process steps. A preliminary pressing of moist fibrous material as known, for example, from the aforementioned DE 10 2019 127 562 A1, differs from a hot pressing process. Such pre-pressing can be carried out additionally, especially with moist materials. However, during pre-pressing, the water is only squeezed out of the fibrous material, where hydrogen bonds cannot yet fully form. As is known, the water is therefore pressed out during pre-pressing only at relatively low temperatures (e.g., <100° C.). Dividing the hot-pressing process into at least two hot-pressing steps contrastingly offers several advantages, as explained above.

Furthermore, the method is not limited to the production of products from a fibrous material in a so-called wet process, but can also be used in the production or forming of products in a so-called dry process.

In other embodiments, the temperature introduced during the second pressing in the second pressing device can be higher than the temperature introduced during the first pressing in the first pressing device, or the temperature introduced in the second pressing device during the second pressing can be lower than the temperature introduced in the first pressing device during the first pressing. If the temperature is increased, pressing can cause an increasing release of water and an increasing bonding of the fibers (e.g., through hydrogen bonding) and therefore an increase in the mechanical properties of the product to be manufactured or the preform. If the temperature decreases, the surface of the preform or product can be reworked and, for example, finished by the at least a second pressing, where the required strength and the removal of water have already been achieved.

In other embodiments, surface finishing can also be achieved under a higher temperature during a subsequent, at least a second pressing process. In yet other embodiments, for example, in three pressing processes, the temperature can be in the sequence of high-low-high or low-high-low.

In other embodiments, the first pressing (as warm pressing) can be carried out within a temperature range of 70 to 120° C., and/or the at least one second pressing (as hot pressing) in a temperature range of 160 to 250° C., or the first pressing (as hot pressing) is carried out within a temperature range of 160 to 250° C. and/or the at least one second pressing (as warm pressing) in a temperature range of 70 to 120° C. In other embodiments, warm pressing can be carried out at about 100° C. and hot pressing at about 220° C. The temperature range for warm pressing enables a reduction in the residual moisture of the preform and the formation of a relatively stable preform for further hot pressing with simultaneous sufficient deformability.

The first pressing does not represent a so-called pre-pressing that can be optionally provided in other embodiments. During pre-pressing, water is usually pressed out of the filter cake of the sucked-in fibers at ambient temperature (+/−20 degrees) in order to obtain a preform that has, for example, a water content of 60% by weight. However, pre-pressing is generally not carried out at temperatures above 100° C.

In other embodiments, first pressing tools of the first pressing device can be heated to 70 to 120° C., and/or second pressing tools of the second pressing device can be heated to 160 to 250° C., or first pressing tools of the first pressing device are heated to 160 to 250° C., and/or second pressing tools of the second pressing device are heated to 70 to 120° C. Heating can be done directly or indirectly, where appropriate heating devices can be provided.

In other embodiments, the moisture content of the preform can be reduced to 30 to 50% by weight during the first pressing in order to achieve the required deformability with sufficient strength. Strength refers to the nature of the preform that affects the cohesion of the employed material. In this case, after the first pressing at a lower temperature (“warm pressing”), a bonding of the individual fibers of the preform has at least partially occurred so that the material is basically stable but still sufficiently deformable. Therefore no “tearing” or the like can occur during deformation, in particular during forming or embossing, where the geometry of a preform is already basically established during the first pressing. Excessive residual moisture in the preform would not allow deformation because compression/stretching can cause the fibers to “flow” or the material in the deformed region to tear, that would damage the preform. The reduction in moisture content can be determined according to the temperature in the pressing devices, the duration of pressing and the pressure. It has been found that adjustments in the parameters of temperature, pressure and residence time (pressing time) have different effects on the result of the respective pressing step so that the reduction of the moisture content and the surface characteristics can be specifically influenced by suitable selection of the parameters.

Temperature control during warm pressing and hot pressing makes it possible to take into account different fibers, pulp compositions, geometries of the products to be manufactured and wall thicknesses, etc. and to provide the corresponding required temperatures. For example, different fibers can require a different warm pressing temperature to achieve the desired formability. Furthermore, a different warm pressing temperature can be required, particularly for thicker walls of a preform than for thinner walls. The pressing force and pressing time during warm pressing and hot pressing can also be different and/or be adjusted depending on the employed material (pulp, fibers, etc.) and the geometry and dimensions of a preform or product.

In other embodiments, the moisture content of the preform can be reduced to 1 to 30% by weight during the second pressing.

In other embodiments, the desired residual moisture in the preform can already be achieved by the first pressing or, if more than three pressing processes are carried out, by at least a second pressing. During at least one additional pressing, pressing then takes place in a dry process as is known, for example, from the forming of paper or the deep drawing of crepe or airlaid. This means that a combination of wet forming and dry forming takes place during hot pressing. In other embodiments, a final forming can be carried out in the dry-hot pressing step.

In other embodiments, not only can different temperatures be used during the first pressing and during at least one second pressing, but the first and second pressing tools can also be heated to a different extent at various locations for the preform. For example, this can ensure that during the first pressing, a first region of a preform is heated more than a second region of the preform so that during the subsequent second pressing, the second region is still sufficiently flexible for forming and/or embossing, but the first region is already correspondingly strongly formed or at least more strongly formed than the second region.

In further embodiments, between and/or during the first pressing and the second pressing, at least one embossing of the preform previously pre-pressed in the first pressing device can take place, where the embossing can include the introduction of contours, grooves, etc. In particular, embossing cannot be understood as pressing as in the first and at least second pressing step. In other embodiments, the embossing takes place during a first or at least a second pressing. Embossing does not represent the introduction of coatings, but can serve as a preparatory measure or for subsequent compaction of previously introduced layers/barrier layers.

In other embodiments, between the first pressing and the at least one second pressing, at least one coating of the preform previously pre-pressed in the first pressing device can take place.

In other embodiments, an additional coating can be carried out before the first pressing and/or after at least one second pressing.

In other embodiments, coating can include at least partial application of at least one additional layer by spraying, dipping, scooping, laminating and/or printing. During coating, additives (such as SiOx) can be applied to a surface of a preform and/or product. After the application of the coating, a second pressing can take place to provide a stronger bond of the surface to the coating or to introduce (“press in”) the coating into the surface of the fibrous material. Furthermore, for example, at least one additional layer of fibers, nanofibers or so-called MFC (microfibrillated cellulose) can be applied after a first pressing and before a second pressing. After the first pressing, the surface of the preform still has sufficient moisture to form a bond with the fibers of the preform located beneath the coating during the second pressing (“fibril aggregation”). The applied fiber layer is connected to the surface of the preform in the at least one second pressing step and forms, for example, a barrier layer and/or gives the surface a special, usually very fine, smooth surface.

The application of different additives or fibers enables the provision of different properties. The layers can be applied in different ways. In other embodiments, several different layers can also be applied to at least a portion of an inner and/or outer surface of a preform and/or product, where in still other embodiments, coating steps can be carried out before a first pressing, between a first and a second pressing, and/or after a second pressing.

In other embodiments, the first pressing and the at least one second pressing can be part of a hot pressing process as described above, where this applies to all embodiments disclosed herein.

In other embodiments, pre-pressing can be carried out before the first pressing, where water is pressed out of the preform.

In other embodiments, the at least one second pressing can result in a surface finishing of the preform previously pre-pressed in the first pressing device. A surface finishing can, for example, include the creation of a smooth surface (“high-gloss surface”). Conventional products made from a fibrous material, in particular those from a wet forming process, have small elevations on their surface that result from pores in the cavities in a hot pressing tool (pressing tool, forming tool) through which water vapor is suctioned during pressing. During surface finishing, these elevations can be pressed “smooth”. For this purpose, the surfaces in the cavities of a second pressing tool or forming tool can be designed smooth so that the elevations are pressed, and the surface of the preforms or form bodies is smooth. In other embodiments, at least one pressing tool of the at least one second pressing device or at least one second forming tool can have steam holes that are located at a different location than steam holes of a first pressing tool of the first pressing device so that the previously created elevations are pressed smooth, and no elevations are created at the steam holes of the at least one second forming tool due to the low moisture in the preform because the material is already too compacted and dried. Such steam holes in cavities of a second forming tool can, for example, remove escaping residual moisture.

Surface finishing can also include embossing, where, for example, patterns or structures are embossed. Embossing causes a compression of the fibrous material that has already been pressed so that the strength and other material properties are improved and, in particular, the surface has a significantly better surface quality (visual, haptic).

In other embodiments, functional and/or designed regions can be reinforced during at least one second pressing. For example, an undercut or edges, etc. can be re-pressed so that they become more stable (e.g., by embossing and introducing structures that additionally compact the material). Furthermore, the reinforcement can bring about a final formation of the functional and/or designed regions, where beforehand, the formed functional and/or designed regions can only be partially formed.

In other embodiments, punching can take place during the first pressing and the at least one second pressing, where the punching takes place to a different extent during the first pressing and the at least one second pressing. Pre-punching can therefore initially occur, where regions of the preform are only partially pre-punched, i.e., both in terms of the punching depth and the punching extent (length, width), and can be finally or additionally punched after or during at least one second pressing. Punching can, for example, occur in the forming tool that can have additional punching tools (blades, etc.).

Products manufactured according to the above-mentioned methods can be, for example, packages for food (e.g., bowls, capsules, boxes, lids, etc.) and packages for consumer goods (e.g., electronic devices, hygiene products, tools, cutlery, etc.) as well as beverage containers and lids therefor. Furthermore, they can be containers for receiving plants (e.g., flower pots, etc.) and decorative elements.

The above-mentioned object is also achieved by a device for forming products from a fibrous material according to one of the methods specified above, at least having:
a first pressing device with first pressing tools, and
at least one second pressing device with second pressing tools.

The technical teaching presented herein enables the production of products from a fibrous material that is provided as a preform with a relatively high residual moisture content of at most 75% by weight, for example approx. 60% by weight, where the product does not have any defects such as cracks, etc. after pressing. The technical teaching also enables the manufacture of products from fibrous material with a relatively low residual moisture, where a special surface quality and the creation/improvement of special design elements (functional: e.g., an undercut) are made possible compared to known dry forming.

For example, complex geometries, e.g., in the region of an edge, can be created by two-stage pressing, where second pressing tools are accordingly designed to form an edge.

In other embodiments, the first pressing tools and/or the second pressing tools can be heated, so that the two-stage process for producing a product such as a container with an edge is further improved. In a first step, for example, a preform of the product can be pre-pressed using the first pressing tools corresponding to the later geometry in the region of its main body and in the region of the edge. By inputting heat, the moisture content of a main body and an edge in the first pressing device can already be reduced, and a bond of the fibers to each other can be achieved. It is crucial in this case that the heating of the preform is only performed to a certain extent in the first pressing device so that the preform is still sufficiently flexible after being pressed in the first pressing device to be able to be deformed in the region of the edge in the second pressing device when closing the second pressing tools. The final production by hot pressing in at least one second pressing device with closed second pressing tools can be carried out at a higher temperature than the heating in the first pressing device, where the water bound in the fibers evaporates, and the preform is hot pressed to form the finished product. Alternatively, certain effects can be achieved by applying an inverse temperature to the fibrous material, as described above.

The first pressing tools and/or the at least one second pressing tools can be brought to the temperatures required for pressing using heating devices. Such heating devices can, for example, be electrical or hydraulic heating devices and can, for example, have heating elements. Electric heating elements can be, for example, heating cartridges, the temperature of which can be regulated according to the provided supply current. The pressing tools can be heated directly via the heating cartridges. Hydraulic heating devices can, for example, have channels running through the pressing tools, where heated oil circulates in the channels. The heating of the pressing tools can be done directly by heating the pressing tools or indirectly by heating a tool plate on/to which the pressing tools are attached. In other embodiments, temperature detection means can be provided that detect the temperature of the pressing tools and/or the tool plate in order to regulate the temperature of the pressing tools in accordance with the detected values.

In other embodiments, the size of cavities in the first pressing device and the second pressing device can be different, where the shrinkage of the volume of the product or preform between the first pressing in the first pressing device and a second pressing in the second pressing device is taken into account.

The device can also have units for coating before a first pressing, between a first and a second pressing, and/or after a second pressing. In the device for forming products from a fibrous material, after at least two-stage pressing, the produced products can be subjected to further processing steps, such as filling, closing, etc.

Further features, embodiments and advantages result from the following illustration of exemplary embodiments with reference to the figures.

### BRIEF DESCRIPTION OF THE FIGURES

In the drawings:

FIG. 1 depicts a schematic representation of a process for manufacturing products from a fibrous material, according to some embodiments.

FIG. 2 depicts a schematic representation of a fiber processing device with a hot pressing station with at least two pressing devices, according to some embodiments.

### DETAILED DESCRIPTION

Various embodiments of the technical teaching described herein are shown below with reference to the figures. Identical reference signs are used in the figure description for identical components, parts and processes. Components, parts and processes that are not essential to the technical teachings disclosed herein or that are obvious to a person skilled in the art are not explicitly reproduced. Features specified in the singular also include the plural unless explicitly stated otherwise. This applies in particular to statements such as “a” or “one.”

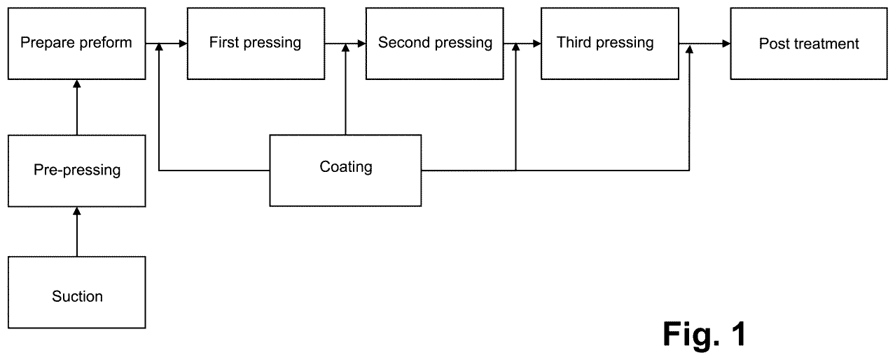

FIG. 1 depicts steps of a method for the manufacture of products from a fibrous material, where preforms made of a fibrous material are first provided, which are then pressed under thermal influence. The preforms can be prepared as described above, where fibers are sucked out of an aqueous solution (pulp) and three-dimensional preforms are formed that substantially already have the shape of the products to be manufactured. In addition, additives such as starch, chemical supplements, wax, etc. can be added to a pulp to influence the properties of the products to be manufactured (e.g., barrier properties) and the processability. The fibers can be, for example, natural fibers, such as cellulose fibers, or fibers from a fiber-containing original material (for example waste paper). For example, biodegradable cups, capsules, bowls, plates and other formed and/or packaging parts (e.g., as holders/support structures for electronic devices) can be produced. Since a fibrous pulp with natural fibers can be used as the starting material for these products, the products manufactured in this way can themselves be used as a starting material for the manufacture of such products after their use, or they can be composted, because they can usually be completely decomposed and do not contain any substances that are harmful to the environment.

In other embodiments, the preforms can be subjected to a pre-pressing step. The preforms are then pressed into three-dimensional products in a hot-pressing device under pressure and the influence of heat. In contrast to known methods for forming such products, pressing is carried out (hot pressing) in at least two steps, i.e., a first pressing and at least a second pressing. In other embodiments, a second pressing can be followed by at least a third pressing, etc. Each pressing can have a targeted influence on various properties of preforms or products.

First, at least one preform is provided. The preform can, for example, have been subject to prepressing in advance to remove water. However, pre-forming is not absolutely necessary. For the forming process, for example, the preform has a residual moisture content of a maximum of 75% by weight. The preform is then placed into a first pressing device. For this purpose, the preform is placed on or inserted into a contact surface of the cavity of the first pressing device. The first pressing device is opened, with two first pressing tool halves displaced relative to each other. After inserting the preform, the first pressing tool halves are moved relative to each other until the first pressing device is closed and a closed cavity for the preform forms. In the first pressing device, a first pressing (“warm pressing”) is then carried out at a relatively low temperature compared to the pressing in a second pressing device. During warm pressing, the moisture content of the preform is reduced, and the preform is preformed.

After warm pressing the preform, the first pressing device is opened by relative displacement of the first two pressing tools, and the warm-pressed preform is removed from the first pressing device. The warm-pressed preform is then fed to the second pressing device. The warm-pressed preform is placed on or inserted into a contact surface of a cavity of the second pressing device. The first pressing device is opened, with two first pressing tool halves displaced relative to each other. After inserting the preform, the second press tool halves are moved relative to each other until the second press device is closed and a closed cavity for the preform forms. In the second pressing device, a second pressing (“hot pressing”) is then carried out at a higher temperature than the pressing in the first pressing device. During the second pressing, the moisture content of the preform is further reduced, and the previously warm-formed preform is pressed into a product, where the product produced in this way is basically no longer deformable and has relatively low residual moisture (1-20% by weight water). After hot pressing, the second pressing device is opened by relative displacement of the second pressing tools, and the hot-pressed product is removed.

The first pressing tools and the second pressing tools have contact surfaces on forming devices that can be moved relative to each other to form a form space (cavity). The forming devices are designed in such a way that the forming devices on one half of the press tool are basically designed as negatives, and the forming devices opposite on the other half of the press tool are basically designed as positives of the products to be formed. In this case, forming devices can be provided as an integral component of tool plates of the press tool halves or can be interchangeably connected to the tool plate of the press tool halves (e.g., screwed).

Furthermore, the first pressing devices and the second pressing devices can in particular have multiple cavities or form spaces and forming devices therefor.

In addition, the form spaces or cavities of the first pressing device can have a different extension and design from the form spaces or cavities of the second pressing device in order to thereby take into account shrinkage of the preforms after the first pressing, and to introduce structures or the like into the surface of already warm-formed preforms. For this purpose, for example, forming devices of the second pressing device can have a patterned or structured surface on the contact surfaces in order to bring a pattern or structuring onto a surface of a warm-formed preform during the second pressing.

In other embodiments, patterns or the like can be embossed between the first pressing in the first pressing device and the second pressing in the second pressing device. For this purpose, the preforms are already sufficiently stable from the first pressing and can then be embossed with a pattern (e.g., brand, slogan, etc.). For this purpose, an embossing device (e.g., embossing station) is arranged between the first pressing device and the second pressing device. The tools for embossing can be designed similarly to the forming devices of the first pressing device and the second pressing device. In other embodiments, embossing means (e.g., stamps or the like) can act only on one region of a warm-formed preform. In other embodiments, the embossing can also be carried out when the first or second pressing devices are open, where the warm-formed preforms rest with their inner or outer surface on a contact surface of a forming device of the first pressing device or the second pressing device. The embossing then takes place after the first pressing in the first pressing device or before the second pressing in the second pressing device with the pressing tool halves open. For this purpose, for example, embossing tools can be moved relative to the press tool halves with the preforms. From this position, the embossing tools then press against the preforms for embossing. In other embodiments, the pressure can be exerted via the opposite pressing tool half that is moved with less pressure and a smaller stroke than in a regular first or second pressing. Afterwards, preforms embossed and warm-formed in this way can be hot-pressed in a second pressing in order to harden the previously introduced embossing by drying the entire preform during hot pressing.

In addition, the different design of the cavities or forming devices for the press tool halves allows for stronger pressing with high pressure after warm pressing or the first pressing, where the wall thickness already reduced by drying during warm pressing can be reduced even further, and the produced product can be made very stable and strong. In addition, this can have a strong impact on the surface characteristics. For example, very strong compaction can be achieved on the surface, which can improve or initially provide barrier properties (moisture, gas and odor permeability).

In other embodiments, coating with additives, fibers, etc. can be carried out before the first pressing, between the first pressing and the second pressing, as well as after the second pressing in order to influence the surface characteristics and barrier properties. A first and/or second pressing after coating can, for example, lead to the activation of additives that are contained in the fibrous material. In addition to pressure, the behavior and bonding ability of materials with each other or with fibers can also be influenced by heated forming devices. In other embodiments, a coating between two pressing steps can realize a targeted layer structure, where a connecting region between at least one coating layer and the adjacent layer (e.g., fiber layer) is relatively small. In other embodiments, several layers can be applied between the first pressing and the second pressing, where the hot-pressed preform is hot-pressed again after coating.

The division of pressing into at least a first pressing and at least a second pressing makes it possible to press preforms sufficiently long and at a sufficiently high temperature and at the same time significantly reduce the time required for pressing under pressure and the simultaneous influence of temperature. It is clear that with additional pressing devices (third pressing device, fourth pressing device, etc.), the duration per pressing device can be reduced even further.

By dividing the system into several pressing devices, where pressing can be realized in each of the pressing devices with the effect of a different temperature, different pressure and different duration, the quality of products manufactured in this way can be significantly improved. In addition, an improvement of barrier properties can be significantly improved. It is particularly important to note in this regard that in a single pressing station, the optimum binding effect of the fibers cannot be achieved due to the limitation to a temperature range for pressing.

The first and second pressing devices have appropriate heating means for the temperature effect, which can provide the temperature at the contact surfaces of the cavities or forming devices in a controlled manner via a controller and, if necessary, other units. For example, electrically controllable heating elements are provided in tool plates and/or forming devices that can be easily controlled via a controller.

In other embodiments, the temperature during a first pressing can be higher than during at least one second pressing, where during the at least one second pressing, the bonding of the fibers of the fibrous material is therefore largely completed. In addition, the preforms can also be embossed in the forming tools themselves, where the forming tools have a corresponding surface in the cavities. In addition, the forming tools can have punching tools that punch the preforms or products in the pressing devices differently when closing the tool halves of the pressing devices. In still other embodiments, punching stations can be provided that are downstream from the pressing devices. Only one punching station can also be provided, where pre-punching can be carried out beforehand in at least one pressing device.

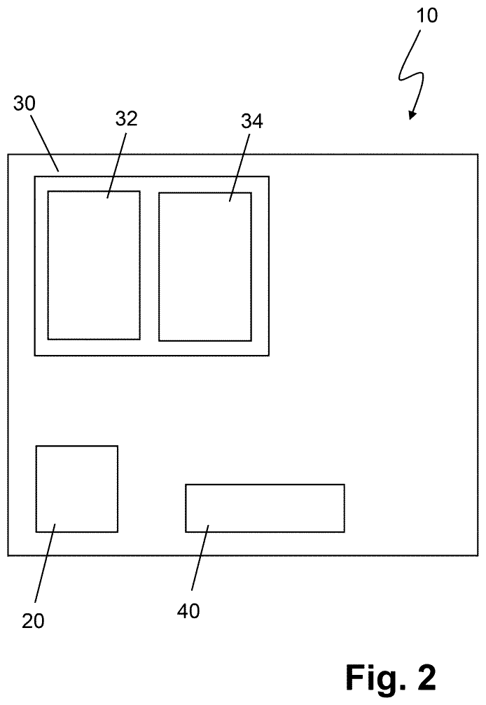

Furthermore, with regard to the embodiment of a fiber processing device 10 in FIG. 2, multi-stage hot pressing can also be carried out on preforms that have a low moisture content and have been produced, for example, from a relatively dry material (e.g., airlaid, etc.).

In the methods described herein, in particular, a surface treatment can also be carried out by the at least two-stage hot pressing process in different hot pressing tools (pressing devices), which provides a compaction and/or smoothing of surfaces. In addition by introducing fine structures, e.g., intersecting lines, etc., a homogeneous compaction can be achieved that usually cannot be realized in a one-stage process because the fibrous material does not have the necessary connection for compaction. Without pre-compaction during the first pressing, fibrous material could remain on (“stick”) to the cavity surface during embossing. This is prevented with the solution described herein.

FIG. 2 depicts a schematic representation of a fiber processing device 10 with a hot pressing station 30 with at least two pressing devices 32, 34. In the shown embodiment, the hot-pressing station 30 of the fiber processing device 10 has a first pressing device 32 for pressing preforms made of fibrous material with a high water content of, for example, 50 to 70% by weight (for example, approximately 60% by weight), as described above. The first pressing in the first pressing device 32 takes place within a temperature range of 70 to 120° C. For this purpose, the pressing tools or pressing tool halves as well as the forming devices can be heated via at least one heating device 40. The heating device 40 can, for example, include electrically controllable heating cartridges that are accommodated in tool bodies of the pressing device 32 or in the associated forming devices.

The hot pressing station 30 also includes a second pressing device 34 for pressing preforms previously pressed in the first pressing device 32 at a lower temperature. After the first pressing, the previously pressed preforms have a water content of, for example, 30 to 50% by weight, for example 35 to 50% by weight, in particular 40-50% by weight, and are therefore sufficiently flexible and deformable so that, for example, an edge, bottom and/or sides of the preforms can be reshaped without damaging or destroying it. For this purpose, the forming device of the second pressing device 34 has a corresponding geometry. The second pressing can be carried out for final drying in a temperature range of 160 to 250° C. For this purpose, the pressing tools or pressing tool halves as well as the forming devices are accordingly heated via at least one heating device 40. The second pressing tools or pressing tool halves as well as the forming devices of the second pressing device 34 can be heated to 160 to 250° C. for this purpose.

In other embodiments, the first pressing in the first pressing device 32 and the second pressing in the second pressing device 34 can take place at substantially the same temperatures. In still other embodiments, the first pressing in the first pressing device 32 can take place at higher temperatures than the second pressing in the second pressing device 34. For example, the surface of the preforms or a previously applied coating can be specifically thermally bonded to a bonding layer/surface of the fibrous material or treated.

The fiber processing device 10 also include a controller 20 that serves to control the components shown in FIG. 2 and other components of the fiber processing device 10.

The fiber processing device 10 can have, for example, processing units, for example, interfaces for the supply of media (for example water, pulp, compressed air, gas, etc.) and energy (power supply), at least one suction device, line systems for the various media, pumps, valves, lines, sensors, measuring devices, a bus system, etc., and interfaces for bidirectional communication via a wired and/or wireless data connection. Instead of a wired data connection, there can also be a data connection via a fiber optic line. The data connection can be, for example, between the controller 20 and a central controller for multiple fiber processing devices 10, to a fiber preparation plant, to a service point, and/or additional devices. It is also possible to control the fiber processing device 10 via a bidirectional data connection via a mobile device, such as a smartphone, tablet computer, or the like. Furthermore, the controller 20 can be in bidirectional communication with an HMI (human-machine interface) panel via a BUS system or a data connection. Additionally or alternatively, additional input means, such as a keyboard, a joystick, a keypad, etc. for operator inputs, can be provided on an HMI panel. In this way, settings can be changed and the operation of the fiber processing device 10 can be influenced.

In other embodiments, the fiber processing device 10 can have devices for preforming and sucking in fibers to form preforms from a pulp. Furthermore, the fiber processing device 10 can have other upstream and downstream processing stations. In addition, as already explained above, the fiber processing device 10 can have stations for coating at different points in the manufacturing process, where these stations can in turn be supplied with material (fibers, SiOx, additives, wax, etc.) for coating via additional devices.

### LIST OF REFERENCE SIGNS

10 Fiber processing device
20 Controller
30 Hot pressing station
32 First pressing device
34 Second pressing device
40 Heating device

1. A method for forming products from a fibrous material, having at least the following steps:
providing a preform made of a fibrous material, wherein the preform has a moisture content of not more than 75% by weight;
first pressing of the preform with simultaneous heat input in a first pressing device; and
at least one second pressing of the preform previously pre-pressed in the first pressing device with simultaneous heat input in a second pressing device;
wherein;
a first temperature introduced during the first pressing in the first pressing device and a second temperature introduced during the at least one second pressing in the second pressing device are different.

2. The method according to claim 1, wherein:
the second temperature introduced during the at least one second pressing in the second pressing device is higher than the first temperature introduced during the first pressing in the first pressing device.

3. The method according to claim 1, wherein:
the second temperature introduced during the at least one second pressing in the second pressing device is lower than the first temperature introduced during the first pressing in the first pressing device.

4. The method according to claim 1, wherein:
the first pressing is carried out within a temperature range of 70 to 120° C., and/or the at least one second pressing is carried out within a temperature range of 160 to 250° C.

5. The method according to claim 1, wherein:
the first pressing is carried out within a temperature range of 160 to 250° C. and/or the at least one second pressing is carried out within a temperature range of 70 to 120° C.

6. The method according to claim 1, wherein:
first pressing tools of the first pressing device are heated to 70 to 120° C., and/or second pressing tools of the second pressing device are heated to 160 to 250° C.

7. The method according to claim 1, wherein:
first pressing tools of the first pressing device are heated to 160 to 250° C., and/or second pressing tools of the second pressing device are heated to 70 to 120° C.

8. The method according to claim 1, wherein during the first pressing, the moisture content of the preform is reduced to 30 to 50% by weight.

9. The method according to claim 1, wherein during the at least one second pressing, the moisture content of the preform is reduced to 1 to 30% by weight.

10. The method according to claim 1, wherein between and/or during the first pressing and the at least one second pressing, at least one embossing of the preform pre-pressed beforehand in the first pressing device takes place.

11. The method according to claim 1, wherein between the first pressing and the at least one second pressing, at least one coating of the preform previously pre-pressed in the first pressing device takes place.

12. The method according to claim 11, wherein the coating includes at least a partial application of at least one additional layer by spraying, dipping, scooping, laminating, and/or printing.

13. The method according to claim 1, wherein an additional coating is carried out before the first pressing and/or after the at least one second pressing.

14. The method according to claim 13, wherein the coating includes at least a partial application of at least one additional layer by spraying, dipping, scooping, laminating, and/or printing.

15. The method according to claim 1, wherein the first pressing and the at least one second pressing are part of a hot pressing process.

16. The method according to claim 1, wherein pre-pressing takes place before the first pressing, and wherein water is pressed out of the preform.

17. The method according to claim 1, wherein the at least one second pressing results in a surface finishing of the preform pre-pressed beforehand in the first pressing device.

18. The method according to claim 1, wherein functional and/or designed regions are reinforced during the at least one second pressing.

19. The method according to claim 1, wherein punching takes place during the first pressing and the at least one second pressing, and wherein the punching takes place to a different extent during the first pressing and the at least one second pressing.

20. A device for forming products from a fibrous material according to the methods according to claim 1, having at least:
a first pressing device with first pressing tools; and
at least one second pressing device with second pressing tools.
